(19) United States
(12) Patent Application Publication
(10) Pub. No.: US 2024/0260558 A1
(43) Pub. Date: Aug. 8, 2024

(54) FISHING BOBBER HAVING AN INTEGRATED LINE SPOOL

(71) Applicant: Rodney Wayne Ingram, Lakeland, FL (US)

(72) Inventor: Rodney Wayne Ingram, Lakeland, FL (US)

(21) Appl. No.: 18/450,391

(22) Filed: Aug. 15, 2023

Related U.S. Application Data
(60) Provisional application No. 63/398,101, filed on Aug. 15, 2022.

(51) Int. Cl. A01K 93/00

(52) U.S. Cl. CPC A01K 93/00

(57) ABSTRACT

Fishing bobbers having an integrated line reel that can be manual or motorized are described.

### FIELD

Some implementations relate generally to fishing bobbers, and, more particularly, to fishing bobbers having an integrated line reel that can be manual or motorized.

### BACKGROUND

Fishing bobbers traditionally are attached to fishing line in one of two ways: as adjustable bobbers that can slide along the fishing line and tied into place bobbers that are at a fixed position on the fishing line. Both conventional types of bobbers have drawbacks and limitations.

For example, the bobbers that attach to the line may slip and change position along the line during fishing, which can cause the depth of the hook to vary. This may cause the hook (and bait or lure) to be placed at a depth that is not desirable for the conditions.

In the conventional tied-in place bobbers, the bobber is not readily adjustable on the line without cutting the line on at least one side and retying the bobber to the line.

Embodiments were conceived in light of the above-mentioned problems and limitations, among other things. The background description provided herein is for the purpose of generally presenting the context of the disclosure. Work of the presently named inventor, to the extent it is described in this background section, as well as aspects of the description that may not otherwise qualify as prior art at the time of filing, are neither expressly nor impliedly admitted as prior art against the present disclosure.

### BRIEF DESCRIPTION OF THE DRAWINGS

FIG. 1 is a diagram showing a side view of an example bobber line spool in accordance with some implementations.

FIG. 2 is a diagram showing a cross-sectional view of an example bobber line spool in accordance with some implementations.

FIG. 3 is a diagram showing a cross-sectional view of an example bobber line spool in accordance with some implementations.

FIG. 4 is a diagram showing a front view of an example bobber line spool in accordance with some implementations.

FIG. 5 is a diagram showing a top view of an example bobber line spool in accordance with some implementations.

FIG. 6 is a diagram showing a side view of an example bobber shell in accordance with some implementations.

FIG. 7 is a diagram showing a front view of an example bobber shell in accordance with some implementations.

FIG. 8 is a diagram showing a side view of an example bobber and integrated line spool in accordance with some implementations.

FIG. 9 is a diagram showing a front view of an example bobber and integrated line spool in accordance with some implementations.

FIG. 10 is a diagram showing an internal view of an example bobber in accordance with some implementations.

FIG. 11 is a diagram showing a side view of an example bobber shell in accordance with some implementations.

FIG. 12 is a diagram showing a front view of an example bobber shell in accordance with some implementations.

FIG. 13 is a diagram showing a side view of an example bobber and integrated line spool in accordance with some implementations.

FIG. 14 is a diagram showing a front view of an example bobber and integrated line spool in accordance with some implementations.

### DETAILED DESCRIPTION

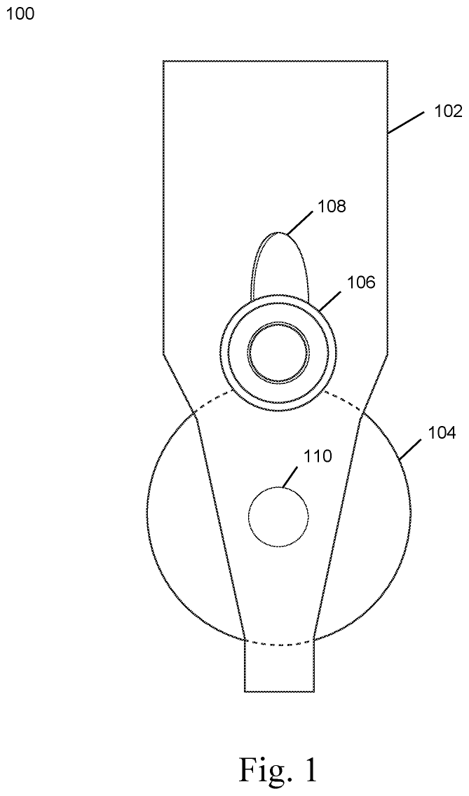

FIG. 1 is a diagram showing a side view of an example bobber line spool 100 in accordance with some implementations. In particular, the bobber line spool 100 includes a frame 102, a line spool 104, a spool release 106, a spool release slot 108, and a spool axle 110.

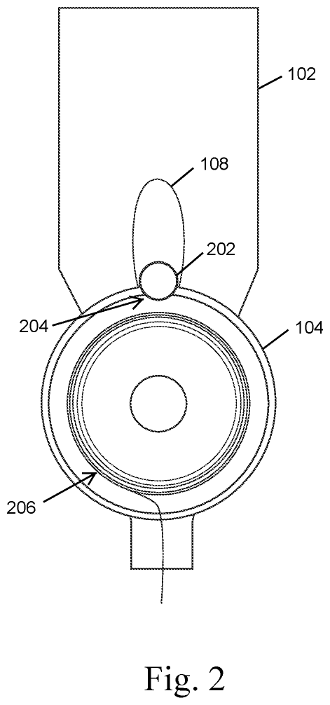

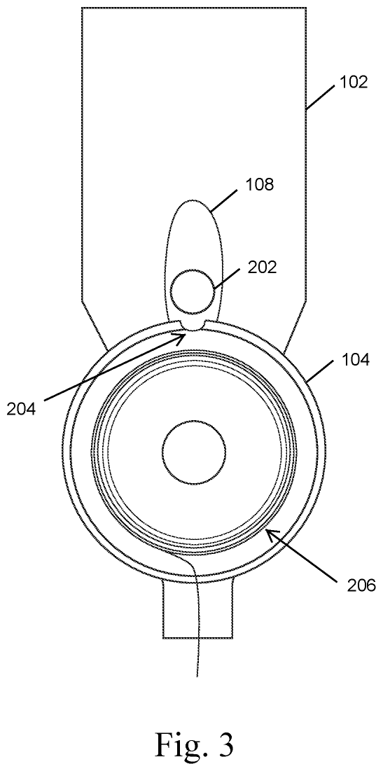

In operation, as shown in FIG. 2, a connecting rod 202 rests in a notch 204 to keep the spool 104 in place and to prevent line 206 from being fed from the spool 104. As shown in FIG. 3, when the rod 202 is raised from the notch 204, the spool 104 is free to rotate to feed line 206 from (or wind line onto) the spool 104.

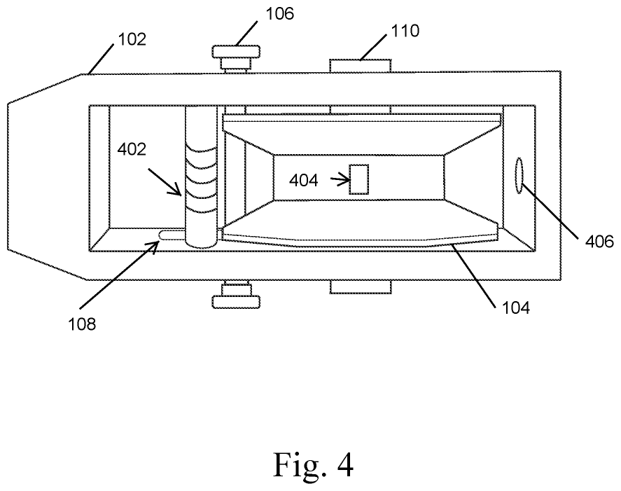

FIG. 4 is a diagram showing a front view of an example bobber line spool 100 in accordance with some implementations. In particular, the bobber line spool 100 includes the elements mentioned above along with a spring anchor rod 402, a line spool aperture 404, a frame aperture 406.

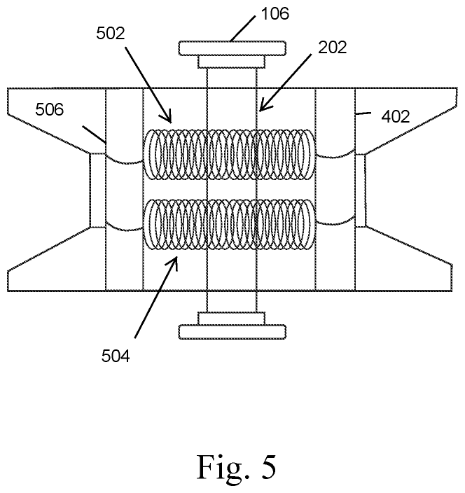

In operation, an end of a line can fed through the frame aperture 406 up to the spool and into the spool aperture 404. The spool release 106 can be raised within slot 108 and against spring pressure applied y springs (502/504 shown in FIG. 5) to permit the spool 104 to rotate and take up line. The springs 502/504 are held in place by spring anchor rods 402 and 506 as shown in FIG. 5.

Once line has been wound onto the spool, the free end of the line can be tired to a hook or lure and the length of free line from the bobber spool to the hook or lure can be adjusted using the spool release 106 and rotating the spool 104 to take up line or to release line. Once the line is at the desired length from the bobber line spool, the spool release 106 can be released and it will engage the notch 204 to lock the spool 104 in place, as shown in FIG. 2.

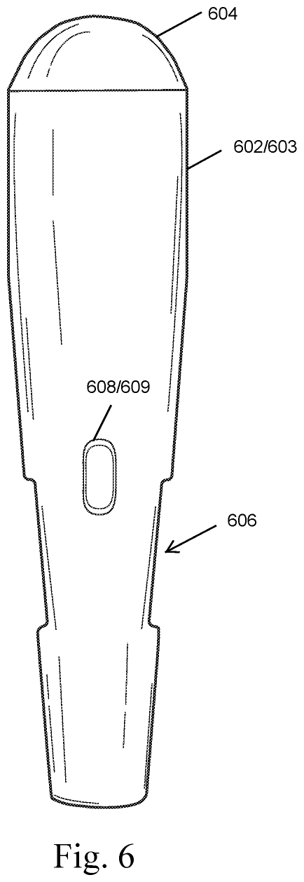

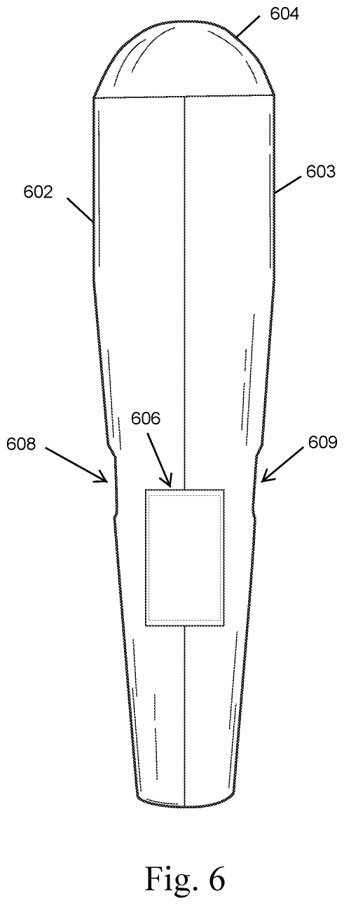

FIGS. 6 and 7 are diagrams showing a side view of an example bobber shell in accordance with some implementations. In particular, the bobber shell includes a first body half 602 and a second body half 603 (not visible), a cap 604, an opening for the bobber line spool 100 spool 104 and openings 608/609 for the spool release 106.

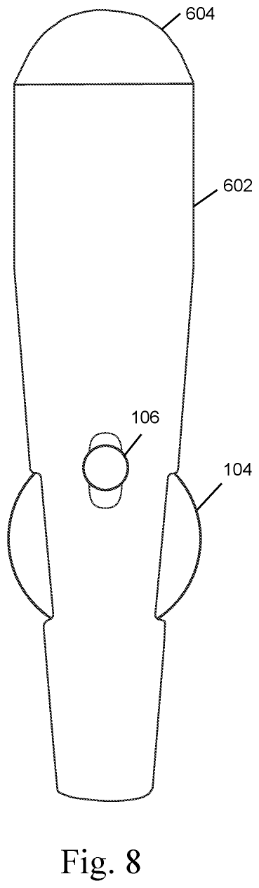

FIG. 8 is a diagram showing a side view of an example bobber and integrated line spool in accordance with some implementations. The bobber line spool 100 spool 104 and spool release 106 are visible outside the bobber body half 602.

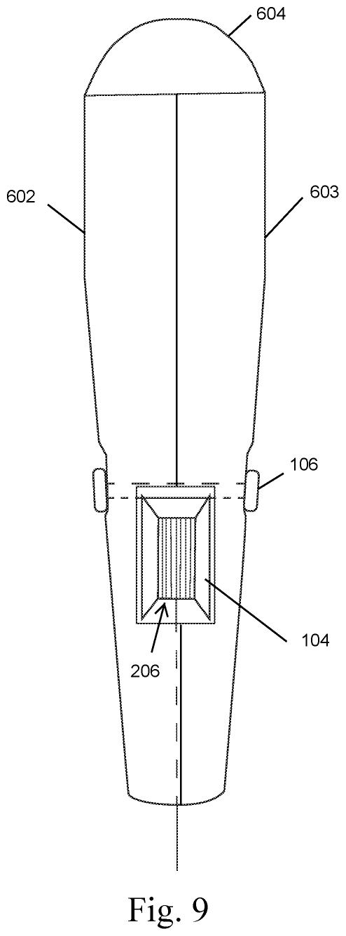

FIG. 9 is a diagram showing a front view of an example bobber and integrated line spool in accordance with some implementations. The bobber line spool 100 spool 104 and spool release 106 and line 206 are visible outside the bobber body half 602.

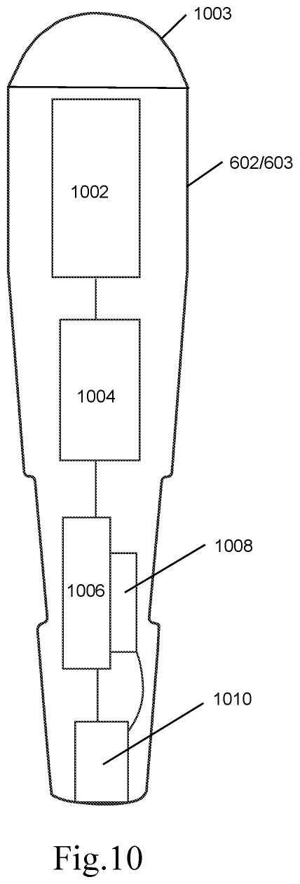

FIG. 10 is a diagram showing an internal view of an example bobber in accordance with some implementations. The components shown in FIG. 10 are optional components that can provide certain features as described below. In particular, a top opening 1002 can be provided. The top opening 1002 can be accessed through the cap 1003, which can screw onto (or off of) the body portion of the bobber. In some implementations, the top opening 1002 can contain rattles to help attract fish. In some implementations, chum (e.g., in tablet or pellet form) can be placed into the top opening and be released through one or more apertures connecting the top opening 1002 to the water the bobber is floating in.

In some implementations, the cap 1003 can be translucent and one or more lights and a power source (e.g., an LED light and battery) can be placed in the top opening 1002. In some implementations, there can be more than one light (e.g., a red light and a green light) to indicate direction or other aspect. In some implementations, the cap 1003 (or body 602/603) can be formed from a glow in the dark material.

In some implementations, a bottom recess 1010 can be provided. The bottom recess 1010 can be configured to hold an optional weight (that can be removable), hold a light source and power supply (e.g., an LED light and battery), hold beads or other rattling or noise making elements, and optionally be reflective to help attract fish.

In some implementations, a loop can be attached to the top of the bobber and used to tie fishing line to the bobber. One or more hooks can be attached to the bobber (e.g., at the bottom) to convert the bobber into a top water plug or other type of artificial lure.

Some implementations can include a radio frequency transmitter (or transceiver) 1004 that can be configured to transmit a signal to indicate when a sensor in the bobber (e.g., 1008) connected to the spool senses a force on the spool (e.g., 1004) caused by movement of the line, which can potentially indicate a fish biting a baited hook or artificial lure attached to the line.

The radio frequency transmitter or transceiver can transmit a signal to a receiver (e.g., attached to a fishing pole or as part of a mobile device such as a phone) to alert the person fishing that a potential bite is occurring.

In some implementations, the bobber can form the case of a survival kit, where fishing supplies can be stowed in the top recess 1002 and/or bottom recess 1010. Other survival items can also be stowed inside the bobber such as matches (or other fire starter), a knife, a life straw, etc. A survival kit version may include two bobbers (e.g., a large one and a small one).

In some implementations, the cap 1003 can be used to turn on or off a light in the top recess 1002 and/or bottom recess 1010, for example, by twisting the cap 1003 or sliding the cap 1003.

In some implementations, the bobber can include a built-in scale at 1006 where the scale can sense the weight on the line connected to the bobber spool 1004. The weight could be displayed on the bobber via an optional display (not shown) or transmitted to another device using the radio frequency connection described above.

Some implementations can include a camera or image sensor disposed in the bobber (e.g., in recess 1010) to capture images of the water beneath the bobber. The camera can take pictures continuously or at time intervals. The camera can also be activated by the bobber detecting motion on the line that may be a fish. Capture images can be stored in the bobber (e.g., in a computer readable memory device) or transmitted from the bobber (e.g., via the radio frequency transmitter/transceiver mentioned above).

In some implementations, an electric motor 1008 that is controlled by control electronics (e.g., in 1004) to rotate the spool 104 to wind and unwind line from the spool 104. Controlling the winding or unwinding of line can provide multiple features. For example, in some implementations, the bobber can release line from the spool 104 until the hook or lure touches the bottom of the body of water the user is fishing in (e.g., for fishing for catfish). The control electronics can release the spool 104 and sense the movement of the spool through the motor 1008 or through a sensor.

In another example of automatically controlling the line from the bobber to the hook or lure, the control electronics can activate the motor 1008 to rotate the spool 104 one direction and then the other to cause the line to move up and down at intervals or randomly in a “jerk bait” fishing style to attract fish.

In yet another example, the control electronics can be configured to slowly release line from the spool 104 so that the bait or lure slowly drops from the bottom of the bobber. The line can be retracted once the baited hook or lure reaches the bottom or all of the line on the spool 104 is used.

In still another example of automatic line control, the electronics in the bobber can sense a fish biting on the baited hook or lure and activate the motor 1008 to retract the line quickly to set the hook on the fish.

In some implementations, a bobber can be clipped onto keys and used as a floating keychain.

In addition to the features described above, exterior wraps (or slip-on visibility band) can be provided to give the bobbers a different appearance. For example, the wraps can include certain colors or patterns to help with visibility. The wraps can also include designs such as animal faces or other designs that might appeal to children and encourage them to fish and learn more about fishing. In some implementations, the slip-on visibility band can include additional buoyancy (e.g., air pockets, foam, etc.).

The bobber body (e.g., 602/603) can be made in various sizes and shapes. For example, a large version of the bobber body can be made such that the bobber can serve as a diver flag and the interior recesses of the bobber can hold ice and beverages or food. A weight can be attached to the bottom of the large bobber implementation via rope to act as an anchor to keep the bobber in place in the water.

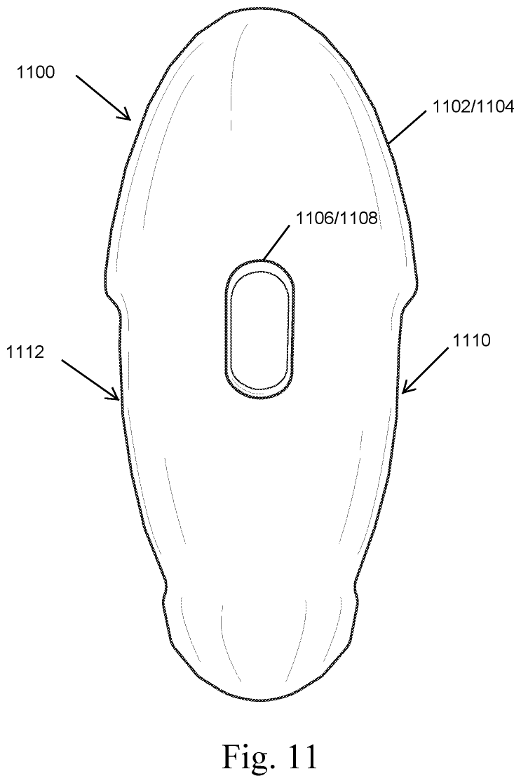

FIG. 11 is a diagram showing a side view of an example bobber shell 1100 in accordance with some implementations. The bobber shell 100 includes a first body portion 1102 and a second body portion 1104 (not visible in FIG. 11), spool release openings 1106/1108, and spool openings 1110 and 1112.

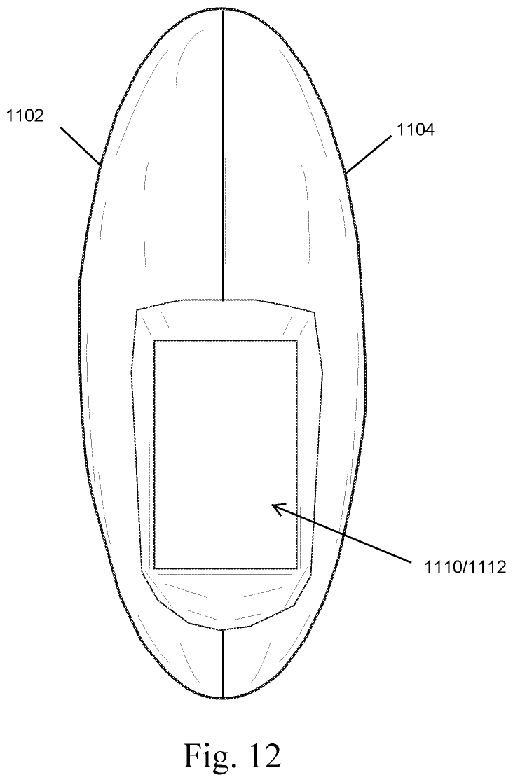

FIG. 12 is a diagram showing a front view of an example bobber shell having a first side shell 1102 and a second side shell 1104. Also shown are spool openings 1110 and 1112

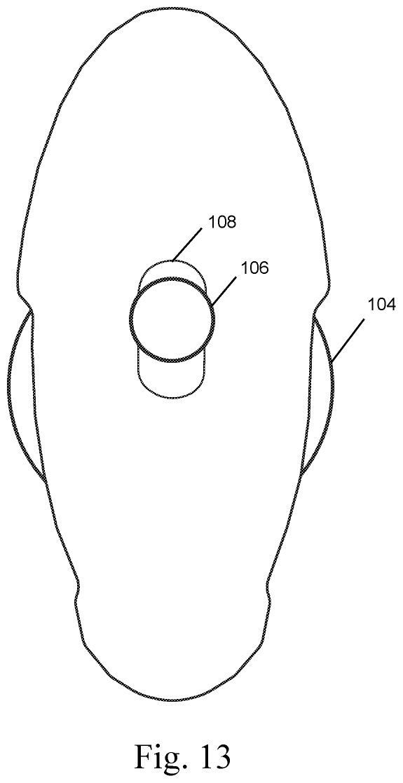

FIG. 13 is a diagram showing a side view of an example bobber and integrated line spool in accordance with some implementations. In particular, the bobber shell of FIGS. 11-12 has the bobber line spool 100 installed and the spool release 106 and spool 104 are visible.

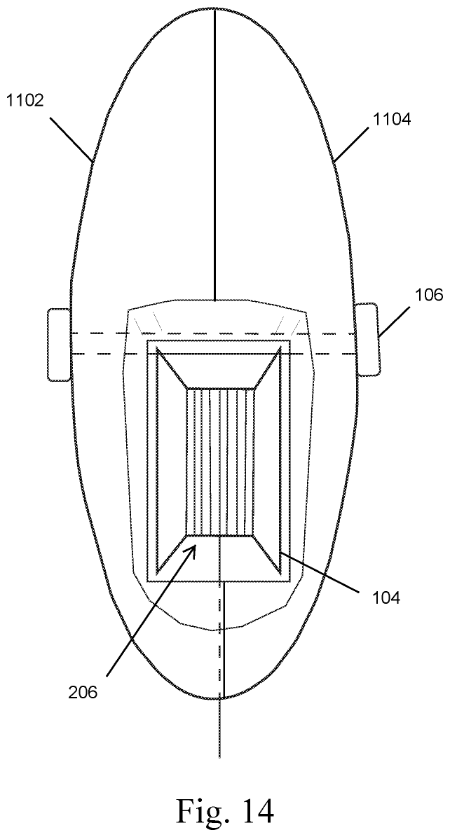

FIG. 14 is a diagram showing a front view of an example bobber and integrated line spool with the spool 104, spool release 106, and line 206 visible.

While some example implementations have been described in terms of a general embodiment with several specific example modifications, it is recognized that other modifications and variations of the embodiments described above are within the spirit and scope of the disclosed subject matter. Applicant intends to embrace any and all such modifications, variations and embodiments.

What is claimed is:

1. A fishing bobber comprising:
a bobber line spool having a frame, a line spool, a spool release, a spool release slot, and a spool axle;
a connecting rod configured to rest in a notch to keep the spool in place and to prevent line from being fed from the spool, wherein when the rod is raised from the notch, the spool is free to rotate to feed line from, or wind line onto, the spool.
